(19) United States
(12) Patent Application Publication
(10) Pub. No.: US 2026/0154829 A1
(43) Pub. Date: Jun. 4, 2026

(54) INFORMATION PROCESSING APPARATUS, INFORMATION PROCESSING SYSTEM, INFORMATION PROCESSING METHOD, AND COMPUTER PROGRAM PRODUCT

(71) Applicant: KABUSHIKI KAISHA TOSHIBA, Tokyo (JP)

(72) Inventors: Yushiro KASHIMOTO, Yokohama (JP); Yuta SHIRAKAWA, Komae (JP); Yuto YAMAJI, Kawasaki (JP); Hiroo SAITO, Kawasaki (JP); Osamu YAMAGUCHI, Yokohama (JP); Yojiro TONOUCHI, Inagi (JP); Shojun NAKAYAMA, Yokohama (JP)

(73) Assignee: KABUSHIKI KAISHA TOSHIBA, Tokyo (JP)

(21) Appl. No.: 19/262,303

(22) Filed: Jul. 8, 2025

(30) Foreign Application Priority Data
Jul. 11, 2024 (JP) 2024-111399

(51) Int. Cl. G06T 7/292; G06T 7/70

(52) U.S. Cl. CPC G06T 7/292; G06T 7/70; G06T 2207/30196

(57) ABSTRACT

An information processing apparatus performs information processing on images captured by cameras. The information processing apparatus includes an association unit, an attribute-information-acquisition unit, a movement-information-generation unit, and an inter-camera information generation unit. The association unit associates, when a mobile object detected from a first-image captured by a first-camera and a mobile object detected from a second-image captured by a second-camera are presumably the same, the mobile object detected from the first-image with the mobile object detected from the second-image. The attribute-information-acquisition unit acquires attribute information regarding a property/feature of the mobile object from the image. The movement-information-generation unit generates movement information regarding movement of the associated mobile object from an imaging-range of the first-camera related to the first-image to an imaging-range of the second-camera related to the second-image. The inter-camera information generation unit generates inter-camera information by statistically processing the movement information according to the attribute information.

### CROSS-REFERENCE TO RELATED APPLICATIONS

This application is based upon and claims the benefit of priority from Japanese Patent Application No. 2024-111399, filed on Jul. 11, 2024; the entire contents of which are incorporated herein by reference.

### FIELD

Embodiments described herein relate generally to an information processing apparatus, an information processing system, an information processing method, and a computer program product.

### BACKGROUND

In order to track a mobile object which is an object that is moving such as a person, an animal, or a robot using a plurality of cameras or search for a position of the mobile object, a program for calculating in advance a relationship between two cameras such as a movement time during which the mobile object moves between the two cameras is known. A program in the related art detects a mobile object from moving image data captured by each of two cameras. Subsequently, in a case where a feature vector of an image portion of the mobile object imaged (captured) by one camera of the two cameras matches a feature vector of an image portion of the mobile object imaged by the other camera of the two cameras, the program in the related art associates the mobile object imaged by the one camera and the mobile object imaged by the other camera as being the same. Then, the program in the related art calculates a relationship between the two cameras on the basis of position and time at which the associated mobile object has exited an imaging range of the one camera and position and time at which the associated mobile object has entered an imaging range of the other camera.

Incidentally, a movement behavior such as a moving speed and a movement route of the mobile object differs depending on characteristics and the like, and for example, in the case of persons, there are individual differences. In addition, the moving speed and the movement route of the mobile object may change due to an environmental change in the movement route, such as the presence of an obstacle on a route, slipperiness caused by a part of the route that is wet, or traffic congestion on the route. As such, by using a plurality of cameras installed on the route or around the route, when tracking a mobile object or searching for the position of the mobile object, there is a case where an accurate result cannot be obtained.

### BRIEF DESCRIPTION OF THE DRAWINGS

FIG. 1 is a configuration diagram of an information processing system according to a first embodiment;

FIG. 2 is a diagram illustrating inter-camera information for each attribute according to the first embodiment;

FIG. 3 is a configuration diagram of a generation device according to the first embodiment;

FIG. 4 is a flowchart illustrating a flow of processing of the generation device according to the first embodiment;

FIG. 5 is a configuration diagram of an information processing system according to a second embodiment;

FIG. 6 is a diagram illustrating inter-camera information for each situation according to the second embodiment;

FIG. 7 is a configuration diagram of a generation device according to the second embodiment;

FIG. 8 is a flowchart illustrating a flow of processing of the generation device according to the second embodiment;

FIG. 9 is a configuration diagram of an information processing system according to a third embodiment;

FIG. 10 is a diagram illustrating inter-camera information for each attribute and each situation according to the third embodiment;

FIG. 11 is a configuration diagram of a generation device according to the third embodiment;

FIG. 12 is a flowchart illustrating a flow of processing of the generation device according to the third embodiment;

FIG. 13 is a flowchart illustrating a flow of processing of the generation device according to a fourth embodiment;

FIG. 14 is a diagram illustrating a first display image;

FIG. 15 is a diagram illustrating a second display image; and

FIG. 16 is a hardware configuration diagram of an information processing apparatus.

### DETAILED DESCRIPTION

According to an embodiment, an information processing apparatus is configured to perform information processing on images captured by a plurality of cameras. The information processing apparatus includes one or more hardware processors configured to function as an association unit, an attribute information acquisition unit, a movement information generation unit, and an inter-camera information generation unit. The association unit associates, in a case where a mobile object detected from a first image captured by a first camera and a mobile object detected from a second image captured by a second camera are estimated to be the same, the mobile object detected from the first image with the mobile object detected from the second image. The attribute information acquisition unit acquires attribute information regarding a property or feature of the mobile object from an image. The movement information generation unit generates movement information regarding movement of the associated mobile object from an imaging range of the first camera related to the first image to an imaging range of the second camera related to the second image. The inter-camera information generation unit generates inter-camera information regarding the mobile object by statistically processing the movement information according to the attribute information.

A problem to be solved by the present disclosure is to enable tracking a mobile object imaged by a plurality of cameras or searching for a position of the mobile object with higher accuracy.

Exemplary embodiments of an information processing apparatus, an information processing system, an information processing method, and a computer program product will be explained below in detail with reference to the accompanying drawings. The present disclosure is not limited to the following embodiments.

### First Embodiment

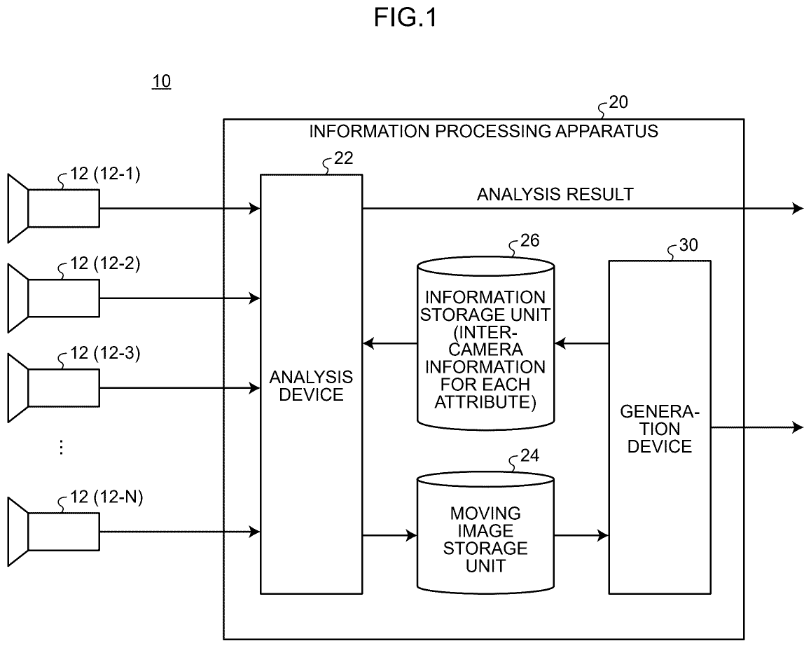

FIG. 1 is a diagram illustrating a configuration of an information processing system 10 according to a first embodiment.

The information processing system 10 includes a plurality of cameras 12 and an information processing apparatus 20. The information processing system 10 performs an analysis regarding movement of a person, such as detection or tracking of a person imaged by the plurality of cameras 12. For example, the information processing system 10 determines the entry and exit of persons by performing detection processing of detecting all or some of the persons in an image, and tracking processing of specifying movement positions per unit time for all or some of the detected persons. Note that the person is an example of a mobile object, and the information processing system 10 may perform an analysis regarding the movement of the mobile object, such as detection or tracking of the mobile object imaged by the plurality of cameras 12.

The plurality of cameras 12 includes, for example, a first camera 12-1, a second camera 12-2, . . . , and an N-th camera 12-N (N is an integer of 2 or more). Each of the plurality of cameras 12 is arranged with an imaging range and an imaging direction fixed. Each of the plurality of cameras 12 generates moving image data obtained by imaging a person present in the imaging range.

Each of the plurality of cameras 12 is installed at different positions or angles, and has different imaging ranges. For example, the second camera 12-2 is disposed at a position or angle different from that of the first camera 12-1. Each of the plurality of cameras 12 may be disposed indoors or outdoors. In addition, in each of the plurality of cameras 12, a part of the imaging range may overlap the imaging range of another camera 12.

The information processing apparatus 20 includes an analysis device 22, a moving image storage unit 24, an information storage unit 26, and a generation device 30.

The analysis device 22 acquires moving image data captured by each of the plurality of cameras 12. The analysis device 22 distinguishes the acquired moving image data for each of the plurality of cameras 12 and writes the acquired moving image data in the moving image storage unit 24. Then, the analysis device 22 performs an analysis regarding the movement of the person on the basis of the moving image data captured by each of the plurality of cameras 12. The analysis device 22 may execute an analysis in real time or may execute an analysis offline on the basis of the moving image data stored in the moving image storage unit 24.

The analysis device 22 outputs an analysis result of the analysis regarding the movement of the person, to an external device. In addition, the analysis device 22 may display the analysis result on a display device.

The moving image storage unit 24 stores the moving image data acquired by the analysis device 22 separately for each of the plurality of cameras 12.

The information storage unit 26 stores, for each set of two cameras 12 included in the plurality of cameras 12, inter-camera information for each attribute of a person such as gender and age.

The generation device 30 generates the inter-camera information for each attribute on the basis of the moving image data for each of the plurality of cameras 12 stored in the moving image storage unit 24. The generation device 30 generates the inter-camera information for each attribute, for each set of two cameras 12 included in the plurality of cameras 12. The set of two cameras 12 is an ordered set in which a person who has exited the imaging range of one camera 12 may enter the imaging range of the other camera 12.

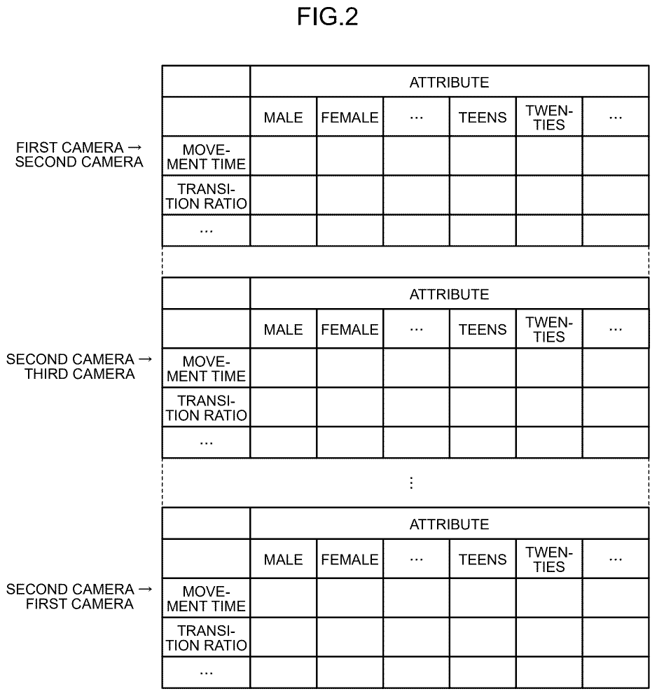

For example, in a case where there is a possibility that a person who has exited the imaging range of the first camera 12-1 enters the imaging range of the second camera 12-2, the generation device 30 generates the inter-camera information for each attribute by setting the first camera 12-1 and the second camera 12-2 as an ordered set of the two cameras 12. Note that the inter-camera information for each attribute will be described in more detail with reference to FIG. 2.

The generation device 30 stores the generated inter-camera information for each attribute in the information storage unit 26. In addition, the generation device 30 may output the generated inter-camera information for each attribute to an external device or may display the generated inter-camera information for each attribute on a display device.

Here, the analysis device 22 specifies the attribute of the person that is an analysis target, and executes an analysis regarding the movement of the person as the analysis target, by using the inter-camera information of the specified attribute among the pieces of inter-camera information for each attribute stored in the information storage unit 26.

For example, in the analysis regarding the movement of the person, the analysis device 22 executes association processing of associating the person who has exited the imaging range of the first camera 12-1 and the person who has entered the imaging range of the second camera 12-2 with each other by using feature information extracted from the appearance, actions, and the like of the persons and the similarity thereof. In this case, the analysis device 22 executes the association processing by narrowing down candidates, correcting the feature information and the similarity thereof, assigning priorities, and the like using the inter-camera information of the specified attribute among the pieces of inter-camera information for each attribute corresponding to the set of the first camera 12-1 and the second camera 12-2.

In many cases, the movement behaviors such as moving speeds or movement routes of persons are different for each attribute such as gender and age. Therefore, for example, the movement time, the movement route, and the like from the exit of the imaging range of the first camera 12-1 to the entry into the imaging range of the second camera 12-2 may be different for each attribute. In a case where the inter-camera information generated regardless of the attribute is used, the analysis device 22 cannot refer to appropriate inter-camera information due to a difference in gender, age, or the like of the person, and there is a possibility that the analysis device 22 may not accurately narrow down candidates, correct the feature information and the similarity thereof, and assign priorities for the association processing. On the other hand, since the analysis device 22 according to the first embodiment uses the inter-camera information for each attribute, the analysis device 22 can accurately narrow down candidates, correct the feature information and the similarity thereof, and assign priorities for the association processing. Therefore, the analysis device 22 according to the first embodiment can accurately or more specifically execute an analysis regarding the movement of the person.

FIG. 2 is a diagram illustrating an example of the inter-camera information for each attribute according to the first embodiment.

The inter-camera information for each attribute is generated for each set of two cameras 12 included in the plurality of cameras 12. The set of two cameras 12 is an ordered set in which the two cameras 12 are arranged in order. For example, a set of the first camera 12-1 and the second camera 12-2 representing a set of orders in which a person who has exited the imaging range of the first camera 12-1 enters the imaging range of the second camera 12-2 is different from a set of the second camera 12-2 and the first camera 12-1 representing a set of orders in which a person who has exited the imaging range of the second camera 12-2 enters the imaging range of the first camera 12-1.

However, the two pieces of inter-camera information in a relationship of the reverse ordered set may have the same content. In this case, the two pieces of inter-camera information in the relationship of the reverse ordered set may be commonly described.

The inter-camera information for each attribute represents, for each attribute, a relationship between one camera 12 and the other camera 12 in a case where a person moves from the imaging range of one camera 12 to the imaging range of the other camera 12 in the set of two cameras 12 arranged in order. For example, the inter-camera information for each attribute of the set of the first camera 12-1 and the second camera 12-2 represents, for each attribute, a relationship between the first camera 12-1 and the second camera 12-2 in a case where a person moves from the imaging range of the first camera 12-1 to the imaging range of the second camera 12-2.

For example, the inter-camera information for each attribute includes a value of at least one item among a movement time, a transition ratio, an exit position, an entry position, an exit angle, an entry angle, an exit direction, and an entry direction.

The movement time represents a time until a person enters the other imaging range from the imaging range of one camera 12 in the set of two cameras 12 arranged in order. For example, the movement time of the set of the first camera 12-1 and the second camera 12-2 represents a time until a person enters the imaging range of the second camera 12-2 after exiting the imaging range of the first camera 12-1.

The transition ratio represents a ratio of the number of people who have moved from the imaging range of one camera 12 to the imaging range of the other camera 12 with respect to the number of people who have exited the imaging range of one camera 12 in the set of two cameras 12 arranged in order. For example, the transition ratio of the set of the first camera 12-1 and the second camera 12-2 represents a ratio of the number of people who have entered the imaging range of the second camera 12-2 from the imaging range of the first camera 12-1 with respect to the number of people who have exited the imaging range of the first camera 12-1.

In addition, the transition ratio may represent a ratio of the number of people who have moved from the imaging range of one camera 12 to the imaging range of the other camera 12 with respect to the number of people who have entered the imaging range of the other camera 12 in the set of two cameras 12 arranged in order. For example, the transition ratio of the set of the first camera 12-1 and the second camera 12-2 may represent a ratio of the number of people who have entered the imaging range of the second camera 12-2 from the imaging range of the first camera 12-1 with respect to the number of people who have entered the imaging range of the second camera 12-2.

The exit position represents a position where a person, who exits the imaging range of one camera 12 and enters the imaging range of the other camera 12 in the set of two cameras 12 arranged in order, exits the imaging range of the one camera 12. For example, the exit position of the set of the first camera 12-1 and the second camera 12-2 represents a position where a person, who exits the imaging range of the first camera 12-1 and enters the imaging range of the second camera 12-2, exits the imaging range of the first camera 12-1.

The entry position represents a position where a person, who exits the imaging range of one camera 12 and enters the imaging range of the other camera 12 in the set of two cameras 12 arranged in order, enters the imaging range of the other camera 12. For example, the entry position of the set of the first camera 12-1 and the second camera 12-2 represents a position where a person, who exits the imaging range of the first camera 12-1 and enters the imaging range of the second camera 12-2, enters the imaging range of the second camera 12-2.

The exit angle represents an angle or an orientation of a body of a person, who exits the imaging range of one camera 12 and enters the imaging range of the other camera 12 in the set of two cameras 12 arranged in order, with respect to the one camera 12 at a time point when the person exits the imaging range of the one camera 12. For example, the exit angle of the set of the first camera 12-1 and the second camera 12-2 represents an angle or an orientation of a body of a person, who exits the imaging range of the first camera 12-1 and enters the imaging range of the second camera 12-2, with respect to the first camera 12-1 at a time point when the person exits the imaging range of the first camera 12-1.

The entry angle represents an angle or an orientation of a body of a person, who exits the imaging range of one camera 12 and enters the imaging range of the other camera 12 in the set of two cameras 12 arranged in order, with respect to the other camera 12 at a time point when the person enters the imaging range of the other camera 12. For example, the entry angle of the set of the first camera 12-1 and the second camera 12-2 represents an angle or an orientation of a body of a person, who exits the imaging range of the first camera 12-1 and enters the imaging range of the second camera 12-2, with respect to the second camera 12-2 at a time point when the person enters the imaging range of the second camera 12-2.

The exit direction represents a movement direction of a person, who exits the imaging range of one camera 12 and enters the imaging range of the other camera 12 in the set of two cameras 12 arranged in order, at a time point when the person exits the imaging range of the one camera 12. For example, the exit direction of the set of the first camera 12-1 and the second camera 12-2 represents a movement direction of a person, who exits the imaging range of the first camera 12-1 and enters the imaging range of the second camera 12-2, at a time point when the person exits the imaging range of the first camera 12-1.

The entry direction represents a movement direction of a person, who exits the imaging range of one camera 12 and enters the imaging range of the other camera 12 in the set of two cameras 12 arranged in order, at a time point when the person enters the imaging range of the other camera 12. For example, the entry direction of the set of the first camera 12-1 and the second camera 12-2 represents a movement direction of a person, who exits the imaging range of the first camera 12-1 and enters the imaging range of the second camera 12-2, at a time point when the person enters the imaging range of the second camera 12-2.

By using such inter-camera information for each attribute, the analysis device 22 can execute the association processing with higher accuracy.

In addition, the inter-camera information for each attribute includes a value of each item for each of the plurality of attributes.

Each of the plurality of attributes is information depending on a person representing a property or a feature of the person. For example, each of the plurality of attributes represents any of gender, age group, clothing, social role, presence or absence of predetermined personal belongings, belongings, presence or absence of accompanying other persons, an action, posture, and facial expression.

The gender is male, female, or the like. The gender may be information indicating neither male nor female, or unknown.

The age group is, for example, a generation such as under 10 years old, teens, twenties, or thirties.

The clothing is, for example, wearing sportswear, business suit, high heel, or the like. The social role is an event guide, a police officer, or the like. The presence or absence of the predetermined belongings is, for example, the presence or absence of a large baggage of a predetermined size or more. The belongings include carrying a suitcase, wearing a backpack, or the like.

The presence or absence of accompanying other persons may be, for example, moving as a group of the predetermined number of people or more. The action is running, moving with large hand motions, or the like. The posture is, for example, looking downward while walking. The facial expression is a pleasant expression, a depressed expression, or the like.

The movement behavior of a person, such as a moving speed and a movement route, is changed depending on such attributes. Therefore, in the case of performing the association processing, the analysis device 22 can execute the association with higher accuracy by using the inter-camera information having the same attribute as the attribute of the person as a target of the association.

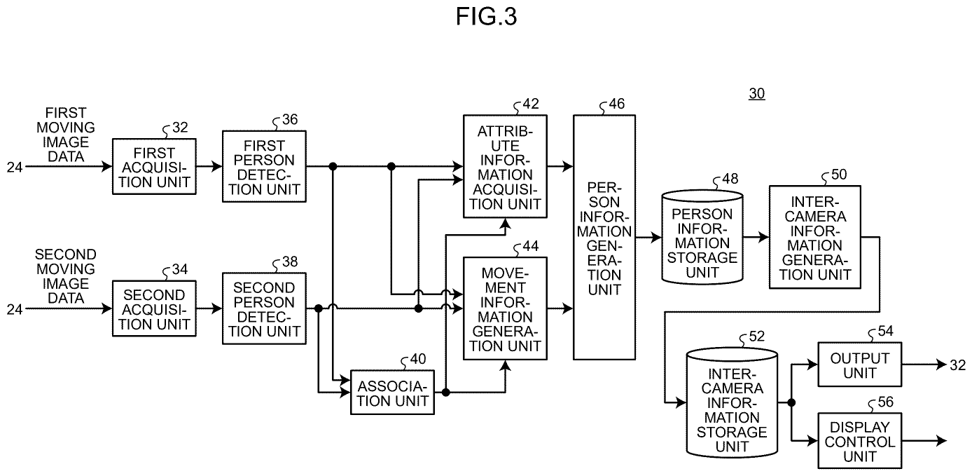

FIG. 3 is a diagram illustrating a configuration of the generation device 30 according to the first embodiment.

The generation device 30 generates inter-camera information for each attribute for the set of the first camera 12-1 and the second camera 12-2 among the plurality of cameras 12. Note that the generation device 30 can also generate inter-camera information for each attribute with the same configuration by processing, for a set of two cameras 12 other than the set of the first camera 12-1 and the second camera 12-2 among the plurality of cameras 12, one of the set of two cameras 12 as the first camera 12-1 and processing the other of the set of two cameras 12 as the second camera 12-2.

The generation device 30 includes a first acquisition unit 32, a second acquisition unit 34, a first person detection unit 36, a second person detection unit 38, an association unit 40, an attribute information acquisition unit 42, a movement information generation unit 44, a person information generation unit 46, a person information storage unit 48, an inter-camera information generation unit 50, an inter-camera information storage unit 52, an output unit 54, and a display control unit 56.

The first acquisition unit 32 acquires first moving image data captured by the first camera 12-1 from the moving image storage unit 24. The second acquisition unit 34 acquires second moving image data captured by the second camera 12-2 from the moving image storage unit 24.

The first person detection unit 36 detects a person who has exited the imaging range of the first camera 12-1 included in the first moving image data captured by the first camera 12-1. The second person detection unit 38 detects a person who has entered the imaging range of the second camera 12-2 included in the second moving image data captured by the second camera 12-2.

The association unit 40 associates each of a plurality of first person images in which a person who has exited the imaging range of the first camera 12-1 is detected, with a second person image that is estimated to include the same person as the corresponding first person image, among a plurality of second person images in which a person who has entered the imaging range of the second camera 12-2, included in the second moving image data captured by the second camera 12-2. At this time, the estimation of whether or not the persons are the same is performed on the basis of one or more pieces of information, including feature information extracted from the appearance or action of the person, the similarity thereof, and the time and location of capture.

For example, the association unit 40 extracts feature information of each of the plurality of first person images and feature information of each of the plurality of second person images. Then, the association unit 40 compares the feature information of each of the plurality of first person images with the feature information of each of the plurality of second person images, and associates the first person image and the second person image that are estimated to include the same person.

In addition, the association unit 40 may generate a value representing the reliability of association together, and associate the first person image with the second person image in a case where the value representing the reliability exceeds a threshold value set in advance. For example, the association unit 40 may determine that the reliability exceeds the threshold value in a case where the similarity is larger than the threshold value, in a case where the degree of dissimilarity is smaller than the threshold value, in a case where the difference in capture time point is within a predetermined range, in a case where a component of the feature vector of a specific element is larger than the threshold value, or a case where at least two of these cases are combined.

Note that the plurality of first person images may include a first person image having no corresponding second person image. The person included in the first person image having no corresponding second person image is estimated to have moved into a range different from the imaging range of the second camera 12-2 from the imaging range of the first camera 12-1.

In addition, the plurality of second person images may include a second person image having no corresponding first person image. The person included in the second person image having no corresponding first person image is estimated to have moved into the imaging range of the second camera 12-2 from a range different from the imaging range of the first camera 12-1.

The attribute information acquisition unit 42 acquires attribute information regarding the property or feature of the mobile object from the image. More specifically, the attribute information acquisition unit 42 acquires one or more corresponding attributes representing the property or feature of a target person included in the associated first person image and second person image, among the plurality of predetermined attributes. Note that in a case where there is a plurality of target persons, the attribute information acquisition unit 42 acquires one or more corresponding attributes for each of the plurality of target persons.

In addition, the attribute information acquisition unit 42 may also acquire one or more corresponding attributes for a person included in the first person image that is not associated with any second person image. In addition, the attribute information acquisition unit 42 may also acquire one or more corresponding attributes for a person included in the second person image that is not associated with any first person image.

For example, the attribute information acquisition unit 42 detects the attribute of the target person included in the associated first person image and second person image, by performing an image analysis on at least one of the first moving image data and the second moving image data. In addition, the attribute information acquisition unit 42 detects the attribute of the person included in the first person image that is not associated with any second person image, by performing an image analysis on the first moving image data. In addition, the attribute information acquisition unit 42 detects the attribute of the person included in the second person image that is not associated with any first person image, by performing an image analysis on the second moving image data.

In addition, the person may have a physical tag or the like from which information indicating the attribute can be detected. In such a case, the attribute information acquisition unit 42 may acquire data such as a physical tag read by a reading device provided together with the first camera 12-1 or the second camera 12-2, and acquire the attribute on the basis of the acquired data such as the physical tag.

The movement information generation unit 44 generates movement information regarding the movement of the target person, who is included in the associated first person image and second person image, from the imaging range of the first camera 12-1 to the imaging range of the second camera 12-2. Note that in a case where there is a plurality of target persons, the movement information generation unit 44 generates the movement information for each of the plurality of target persons.

The movement information includes information that is a source of a value of each item in the inter-camera information for each attribute. For example, the movement information includes a value of at least one item among a movement time, an exit position, an entry position, an exit angle, an entry angle, an exit direction, and an entry direction. The movement information generation unit 44 calculates a value of each item for the target person included in the associated first person image and second person image on the basis of the first moving image data and the second moving image data.

The person information generation unit 46 generates person information including one or more corresponding attributes and movement information for the target person included in the associated first person image and second person image. In a case where there is a plurality of target persons, the person information generation unit 46 generates the person information for each of the plurality of target persons.

In addition, the person information generation unit 46 may generate, for the person included in the first person image that is not associated with any second person image, person information including one or more corresponding attributes and information indicating that the person has exited the imaging range of the first camera 12-1 but has not entered the imaging range of the second camera 12-2.

In addition, the person information generation unit 46 may generate, for the person included in the second person image that is not associated with any first person image, person information including one or more corresponding attributes and information indicating that the person has entered the imaging range of the second camera 12-2 without exiting the imaging range of the first camera 12-1.

The person information storage unit 48 stores the person information of each of the plurality of persons generated by the person information generation unit 46.

The inter-camera information generation unit 50 generates the inter-camera information regarding the mobile object by statistically processing the movement information according to the attribute information. More specifically, the inter-camera information generation unit 50 generates the inter-camera information of the set of the first camera 12-1 and the second camera 12-2 for each of the plurality of attributes on the basis of the person information of each of the plurality of persons stored in the person information storage unit 48.

For example, the inter-camera information generation unit 50 generates inter-camera information for each of the plurality of attributes by performing statistical calculation, for each of the plurality of attributes, on a value of each item of the movement time, the exit position, the entry position, the exit angle, the entry angle, the exit direction, and the entry direction included in the movement information of the plurality of target persons included in the associated first person image and second person image.

For example, the inter-camera information generation unit 50 selects one or more target persons including any first attribute among the plurality of attributes as one or more corresponding attributes, among the plurality of target persons. Subsequently, the inter-camera information generation unit 50 calculates an average value, a median, a standard deviation, or a quartile deviation of the values of each item of the movement time, the exit position, the entry position, the exit angle, the entry angle, the exit direction, and the entry direction included in the movement information of the one or more selected target persons. Then, the inter-camera information generation unit 50 sets the average value, the median, the standard deviation, or the quartile deviation of the values of each item, as the value of each item of the movement time, the exit position, the entry position, the exit angle, the entry angle, the exit direction, and the entry direction in the inter-camera information of the first attribute. Note that the inter-camera information generation unit 50 may use not only the average value, the median, the standard deviation, or the quartile deviation of the values of the items included in the movement information of the one or more selected target persons, and but also other values obtained by the statistical calculation, as the value of the corresponding item in the inter-camera information.

In addition, the inter-camera information generation unit 50 may calculate, for each of the plurality of attributes, a ratio of the number of people who have entered the imaging range of the second camera 12-2 from the imaging range of the first camera 12-1 with respect to the number of people who have exited the imaging range of the first camera 12-1, as the value of the item of the transition ratio in the inter-camera information. In addition, the inter-camera information generation unit 50 may calculate, for each of the plurality of attributes, a ratio of the number of people who have entered the imaging range of the second camera 12-2 from the imaging range of the first camera 12-1 with respect to the number of people who have entered the imaging range of the second camera 12-2, as the value of the item of the transition ratio in the inter-camera information.

Then, the inter-camera information generation unit 50 stores the inter-camera information for each of the plurality of attributes in the inter-camera information storage unit 52.

The output unit 54 writes the inter-camera information for each of the plurality of attributes stored in the inter-camera information storage unit 52, as the inter-camera information for each attribute in the information storage unit 26. The display control unit 56 displays the generated inter-camera information for each of the plurality of attributes on the display device or the like in accordance with, for example, a user's operation or the like.

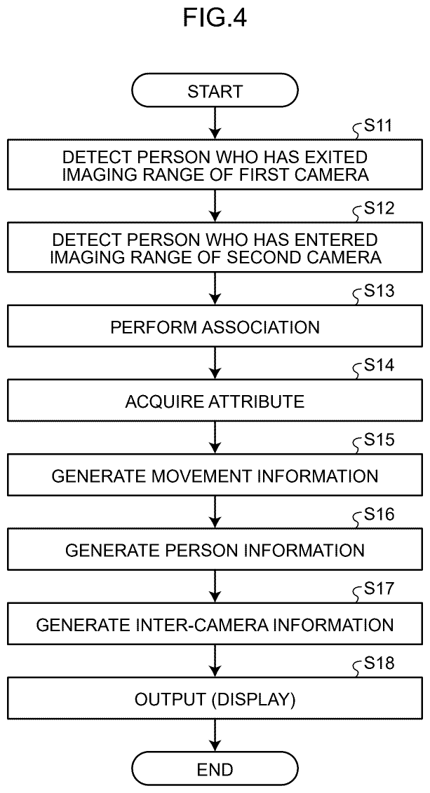

FIG. 4 is a flowchart illustrating a flow of processing of the generation device 30 according to the first embodiment. The generation device 30 according to the first embodiment executes processing in the flow illustrated in FIG. 4, for example.

First, in S11, the generation device 30 detects a person who has exited the imaging range of the first camera 12-1 included in the first moving image data captured by the first camera 12-1.

Subsequently, in S12, the generation device 30 detects a person who has entered the imaging range of the second camera 12-2 included in the second moving image data captured by the second camera 12-2.

Subsequently, in S13, the generation device 30 associates each of the plurality of first person images in which a person who has exited the imaging range of the first camera 12-1 is detected, with the second person image that is estimated to include the same person as the corresponding first person image, among the plurality of second person images in which a person who has entered the imaging range of the second camera 12-2, included in the second moving image data captured by the second camera 12-2.

Subsequently, in S14, the generation device 30 acquires one or more corresponding attributes representing the property or feature of the target person included in the associated first person image and second person image, among the plurality of predetermined attributes. In addition, the generation device 30 acquires one or more corresponding attributes for the person included in the first person image that is not associated with any second person image and the person included in the second person image that is not associated with any first person image.

Subsequently, in S15, the generation device 30 generates the movement information for the target person included in the associated first person image and second person image. For example, the generation device 30 generates the movement information including a value of at least one item among the movement time, the exit position, the entry position, the exit angle, the entry angle, the exit direction, and the entry direction, for the target person.

Subsequently, in S16, the generation device 30 generates person information including one or more corresponding attributes and movement information for the target person included in the associated first person image and second person image. In addition, for a person included in the first person image that is not associated with any second person image and a person included in the second person image that is not associated with any first person image, the generation device 30 also generates person information including one or more corresponding attributes and information indicating that the person has not moved from the imaging range of the first camera 12-1 to the imaging range of the second camera 12-2.

Subsequently, in S17, the generation device 30 generates the inter-camera information of the set of the first camera 12-1 and the second camera 12-2 for each of the plurality of attributes on the basis of the person information of each of the plurality of persons. For example, the generation device 30 generates inter-camera information for each of the plurality of attributes by performing statistical calculation, for each of the plurality of attributes, on a value of each item of the movement time, the exit position, the entry position, the exit angle, the entry angle, the exit direction, and the entry direction included in the movement information of the plurality of target persons included in the associated first person image and second person image.

In addition, the generation device 30 may calculate, for each of the plurality of attributes, a ratio of the number of people who have entered the imaging range of the second camera 12-2 from the imaging range of the first camera 12-1 with respect to the number of people who have exited the imaging range of the first camera 12-1, as the value of the item of the transition ratio in the inter-camera information. In addition, the generation device 30 may calculate, for each of the plurality of attributes, a ratio of the number of people who have entered the imaging range of the second camera 12-2 from the imaging range of the first camera 12-1 with respect to the number of people who have entered the imaging range of the second camera 12-2, as the value of the item of the transition ratio in the inter-camera information.

Subsequently, in S18, the generation device 30 outputs the inter-camera information for each of the plurality of attributes, as the inter-camera information for each attribute to the information storage unit 26. In addition, the generation device 30 may display the generated inter-camera information for each of the plurality of attributes on a display device or the like.

When the processing of S18 is completed, the generation device 30 ends this flow.

As described above, the generation device 30 according to the first embodiment generates, for each attribute of a person, inter-camera information representing the relationship between the first camera 12-1 and the second camera 12-2 in a case where the person moves from the imaging range of the first camera 12-1 to the imaging range of the second camera 12-2. The movement behavior such as a moving speed and a movement route of a person has large individual differences. By generating the inter-camera information for each attribute of a person, the generation device 30 according to the first embodiment can generate inter-camera information for each person whose movement behavior such as a moving speed and a movement route exhibits similar tendencies. As a result, with the information processing system 10 according to the first embodiment, it is possible to generate inter-camera information accurately representing the relationship between the first camera 12-1 and the second camera 12-2. In addition, with the information processing system 10 according to the first embodiment, since the inter-camera information for each attribute generated by the generation device 30 is used, the movement of a person can be analyzed with high accuracy.

### Second Embodiment

Next, the information processing system 10 according to a second embodiment will be described. Since the information processing system 10 according to the second embodiment has substantially the same constituents and functions as those of the information processing system 10 according to the first embodiment described with reference to FIGS. 1 to 4, the same reference numbers are given for substantially the same constituents, and detailed descriptions are omitted except for points of difference.

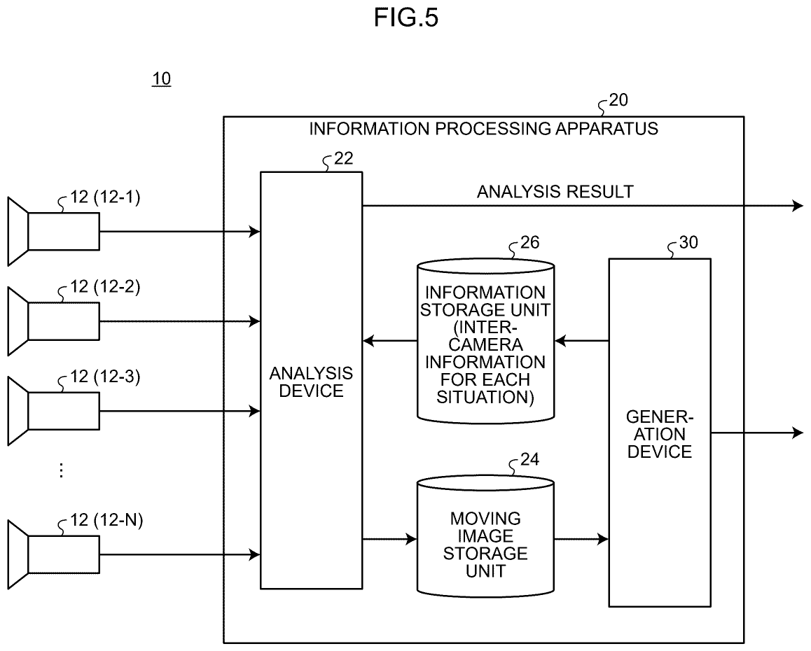

FIG. 5 is a diagram illustrating a configuration of the information processing system 10 according to the second embodiment.

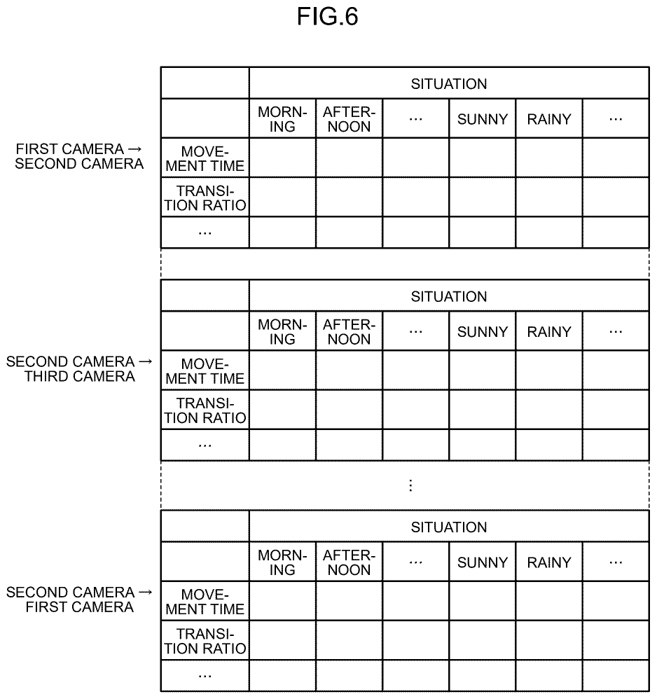

The generation device 30 generates, for each set of two cameras 12 included in the plurality of cameras 12, inter-camera information for each situation such as surrounding weather, a surrounding congestion level, and a state of a road. Note that the inter-camera information for each situation will be described in more detail with reference to FIG. 6.

The generation device 30 stores the generated inter-camera information for each situation in the information storage unit 26. In addition, the generation device 30 may output the generated inter-camera information for each situation to an external device or may display the generated inter-camera information for each situation on a display device.

The information storage unit 26 stores the inter-camera information for each situation, for each set of two cameras 12 included in the plurality of cameras 12.

Here, the analysis device 22 specifies the surrounding situation of the set of two cameras 12, and executes an analysis regarding the movement of the person as the analysis target, by using the inter-camera information of the specified situation among the pieces of inter-camera information for each situation stored in the information storage unit 26.

For example, in the analysis regarding the movement of the person, the analysis device 22 executes association processing of associating the person who has exited the imaging range of the first camera 12-1 and the person who has entered the imaging range of the second camera 12-2 with each other. In this case, the analysis device 22 executes the association processing by using the inter-camera information of the specified situation among the pieces of inter-camera information for each situation corresponding to the set of the first camera 12-1 and the second camera 12-2.

In many cases, the moving speeds or movement routes of persons are different depending on surrounding weather, a surrounding congestion level, or a state of a road. Therefore, for example, the movement time, the movement route, and the like from the exit of the imaging range of the first camera 12-1 to the entry into the imaging range of the second camera 12-2 may be different for each situation. In a case where the analysis device 22 uses the inter-camera information generated regardless of the situation, there is a possibility that the association processing cannot be executed with high accuracy due to a difference in the situation. On the other hand, since the analysis device 22 according to the second embodiment performs association using the inter-camera information for each situation, the association processing can be executed with high accuracy. Therefore, the analysis device 22 according to the second embodiment can accurately or more specifically execute an analysis regarding the movement of the person.

FIG. 6 is a diagram illustrating an example of the inter-camera information for each situation according to the second embodiment.

The inter-camera information for each situation is generated for each set of two cameras 12, which are arranged in order, included in the plurality of cameras 12. For example, the inter-camera information for each situation includes a value of at least one item among the movement time, the transition ratio, the exit position, the entry position, the exit angle, the entry angle, the exit direction, and the entry direction.

In addition, the inter-camera information for each situation includes a value of each item for each of the plurality of situations.

Each of the plurality of situations is information independent of a person in an area between the imaging range of the first camera 12-1 and the imaging range of the second camera 12-2. For example, each of the plurality of situations represents any of a time zone, a day, a month, a day of the week, a congestion level, weather information, presence or absence of an obstacle, an imaging direction of the first camera 12-1, and an imaging direction of the second camera 12-2.

The time zone represents a range of time obtained by dividing one day. For example, the time zone may be a commuting time zone, a non-commuting time zone, or the like. In addition, the time zone may be a time range obtained by dividing a time in a day for each predetermined time. In addition, the time zone may be a time range such as morning, daytime, evening, and night.

The day and the month may be a period unit of a day obtained by dividing one month by a predetermined number of days, a period unit of a month obtained by dividing one year by a predetermined number of months, or a season unit obtained by dividing one year by a season.

The day of the week may be a range obtained by dividing one week by a day unit, or may be a unit obtained by dividing one week into weekdays and weekends.

The congestion level represents a degree of congestion on a movement path of a person from the imaging range of the first camera 12-1 to the imaging range of the second camera 12-2.

The weather information is weather such as rainy or sunny, temperature, humidity or the like in the area between the imaging range of the first camera 12-1 and the imaging range of the second camera 12-2.

The presence or absence of an obstacle represents whether or not there is an obstacle on a movement path from the imaging range of the first camera 12-1 to the imaging range of the second camera 12-2.

The imaging direction of the first camera 12-1 represents an installation angle of the first camera 12-1. The imaging direction of the first camera 12-1 may represent, for example, whether or not the first camera 12-1 is installed in a normal imaging direction, whether or not the first camera 12-1 is installed in an imaging direction different from the normal imaging direction in a case where the first camera 12-1 cannot be installed in the normal imaging direction due to an obstacle such as a vehicle, or the like.

The imaging direction of the second camera 12-2 represents an installation angle of the second camera 12-2. The imaging direction of the second camera 12-2 may represent, for example, whether or not the second camera 12-2 is installed in a normal imaging direction, whether or not the second camera 12-2 is installed in an imaging direction different from the normal imaging direction in a case where the second camera 12-2 cannot be installed in the normal imaging direction due to an obstacle such as a vehicle, or the like.

The movement behavior of a person, such as a moving speed and a movement route, is changed depending on such situations. Therefore, in the case of performing the association processing, the analysis device 22 can execute the association with higher accuracy by using the inter-camera information having the same situation as the situation at the time of analysis.

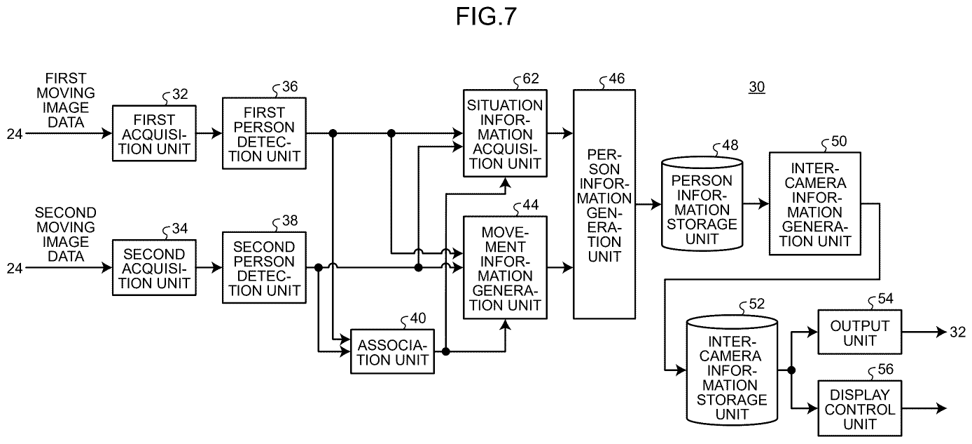

FIG. 7 is a diagram illustrating a configuration of the generation device 30 according to the second embodiment.

In a case of being compared with the generation device 30 according to the first embodiment, the generation device 30 according to the second embodiment includes a situation information acquisition unit 62 instead of the attribute information acquisition unit 42.

The situation information acquisition unit 62 acquires situation information representing a surrounding situation of the associated mobile object. More specifically, the situation information acquisition unit 62 acquires one or more corresponding situations at the time of movement of the target person included in the associated first person image and second person image, among a plurality of predetermined situations in the area between the imaging range of the first camera 12-1 and the imaging range of the second camera 12-2. Note that in a case where there is a plurality of target persons, the situation information acquisition unit 62 acquires one or more corresponding situations for each of the plurality of target persons.

In addition, the situation information acquisition unit 62 may also acquire one or more corresponding situations at the time of exit from the imaging range of the first camera 12-1, for the person included in the first person image that is not associated with any second person image. In addition, the situation information acquisition unit 62 may also acquire one or more corresponding situations at the time of entry into the imaging range of the second camera 12-2, for the person included in the second person image that is not associated with any first person image.

The situation information acquisition unit 62 detects a situation on the basis of time points at the time of exit from the imaging range of the first camera 12-1 and at the time of entry into the imaging range of the second camera 12-2 for the target person included in the associated first person image and second person image, for example. In addition, the situation information acquisition unit 62 detects a situation on the basis of a time point at the time of exit from the imaging range of the first camera 12-1 for the person included in the first person image that is not associated with any second person image. In addition, the situation information acquisition unit 62 detects a situation on the basis of a time point at the time of entry into the imaging range of the second camera 12-2 for the person included in the second person image that is not associated with any first person image.

The situation information acquisition unit 62 may detect the congestion level and the presence or absence of an obstacle at the corresponding time point by analyzing at least one of the first moving image data captured by the first camera 12-1 and the second moving image data captured by the second camera 12-2. In addition, for example, the situation information acquisition unit 62 may detect the congestion level and the presence or absence of an obstacle at the corresponding time point from an external server device that provides the road situation and the like via a network. In addition, for example, the situation information acquisition unit 62 may detect the weather information at the corresponding time point from an external server device that provides the weather information via a network. The situation information acquisition unit 62 may detect the imaging direction of the first camera 12-1 and the imaging direction of the second camera 12-2 by referring to a setting value of an administrator or the like.

In the second embodiment, the person information generation unit 46 generates person information including one or more corresponding situations and movement information for the target person included in the associated first person image and second person image. In a case where there is a plurality of target persons, the person information generation unit 46 generates the person information for each of the plurality of target persons.

In addition, the person information generation unit 46 may generate, for the person included in the first person image that is not associated with any second person image, person information including one or more corresponding situations and information indicating that the person has exited the imaging range of the first camera 12-1 but has not entered the imaging range of the second camera 12-2.

In addition, the person information generation unit 46 may generate, for the person included in the second person image that is not associated with any first person image, person information including one or more corresponding situations and information indicating that the person has entered the imaging range of the second camera 12-2 without exiting the imaging range of the first camera 12-1.

The inter-camera information generation unit 50 generates the inter-camera information regarding the mobile object by statistically processing the movement information according to the situation information. More specifically, the inter-camera information generation unit 50 generates the inter-camera information of the set of the first camera 12-1 and the second camera 12-2 for each of the plurality of situations on the basis of the person information of each of the plurality of persons stored in the person information storage unit 48.

For example, the inter-camera information generation unit 50 generates inter-camera information for each of the plurality of situations by performing statistical calculation, for each of the plurality of situations, on a value of each item of the movement time, the exit position, the entry position, the exit angle, the entry angle, the exit direction, and the entry direction included in the movement information of the plurality of target persons included in the associated first person image and second person image.

For example, the inter-camera information generation unit 50 selects one or more target persons including any first situation among the plurality of situations as one or more corresponding situations, among the plurality of target persons. Subsequently, the inter-camera information generation unit 50 calculates an average value, a median, a standard deviation, or a quartile deviation of the values of each item of the movement time, the exit position, the entry position, the exit angle, the entry angle, the exit direction, and the entry direction included in the movement information of the one or more selected target persons. Then, the inter-camera information generation unit 50 sets the average value, the median, the standard deviation, or the quartile deviation of the values of each item, as the value of each item of the movement time, the exit position, the entry position, the exit angle, the entry angle, the exit direction, and the entry direction in the inter-camera information of the first situation.

In addition, the inter-camera information generation unit 50 may calculate, for each of the plurality of situations, a ratio of the number of people who have entered the imaging range of the second camera 12-2 from the imaging range of the first camera 12-1 with respect to the number of people who have exited the imaging range of the first camera 12-1, as the value of the item of the transition ratio in the inter-camera information. In addition, the inter-camera information generation unit 50 may calculate, for each of the plurality of situations, a ratio of the number of people who have entered the imaging range of the second camera 12-2 from the imaging range of the first camera 12-1 with respect to the number of people who have entered the imaging range of the second camera 12-2, as the value of the item of the transition ratio in the inter-camera information.

Then, the inter-camera information generation unit 50 stores the inter-camera information for each of the plurality of situations in the inter-camera information storage unit 52.

In the second embodiment, the output unit 54 writes the inter-camera information for each of the plurality of situations stored in the inter-camera information storage unit 52, as the inter-camera information for each situation in the information storage unit 26. In the second embodiment, the display control unit 56 displays the generated inter-camera information for each of the plurality of situations on the display device or the like in accordance with, for example, a user's operation or the like.

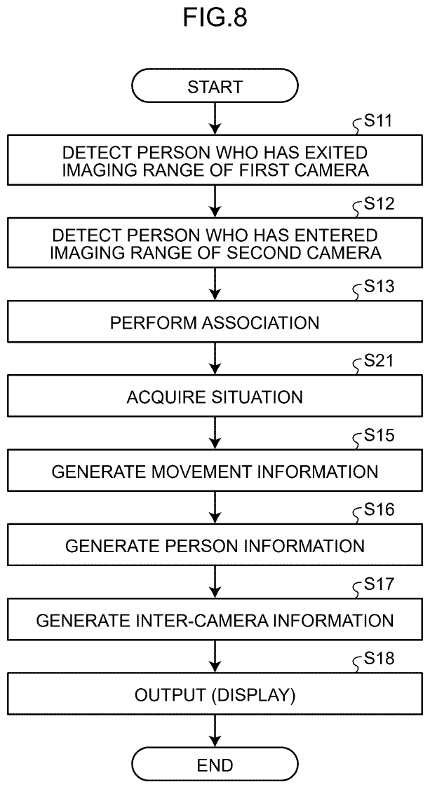

FIG. 8 is a flowchart illustrating a flow of processing of the generation device 30 according to the second embodiment. The generation device 30 according to the second embodiment executes processing in the flow illustrated in FIG. 8, for example.

In a case of being compared with the generation device 30 according to the first embodiment, the generation device 30 according to the second embodiment executes processing of S21 instead of the processing of S14. Therefore, for the generation device 30 according to the second embodiment, the processing from S21 onward will be described.

The generation device 30 according to the second embodiment executes the processing of S21 after executing the processing of S13.

Subsequently, in S21, the generation device 30 acquires one or more corresponding situations at the time of the movement of the target person included in the associated first person image and second person image, among the plurality of predetermined situations. In addition, the generation device 30 acquires one or more corresponding situations for the person included in the first person image that is not associated with any second person image and the person included in the second person image that is not associated with any first person image.

The generation device 30 executes the processing of S15 subsequent to S21. In S15, the generation device 30 generates the movement information for the target person included in the associated first person image and second person image.

Subsequently, in S16, the generation device 30 generates person information including one or more corresponding situations and movement information for the target person included in the associated first person image and second person image. In addition, for a person included in the first person image that is not associated with any second person image and a person included in the second person image that is not associated with any first person image, the generation device 30 also generates person information including one or more corresponding situations and information indicating that the person has not moved from the imaging range of the first camera 12-1 to the imaging range of the second camera 12-2.

Subsequently, in S17, the generation device 30 generates the inter-camera information of the set of the first camera 12-1 and the second camera 12-2 for each of the plurality of situations on the basis of the person information of each of the plurality of persons.

Subsequently, in S18, the generation device 30 outputs the inter-camera information for each of the plurality of situations, as the inter-camera information for each situation to the information storage unit 26. In addition, the generation device 30 may display the generated inter-camera information for each of the plurality of situations on a display device or the like.

When the processing of S18 is completed, the generation device 30 ends this flow.

As described above, the generation device 30 according to the second embodiment generates, for each situation, inter-camera information representing the relationship between the first camera 12-1 and the second camera 12-2 in a case where the person moves from the imaging range of the first camera 12-1 to the imaging range of the second camera 12-2. The moving speed, the movement route, and the like of the person are greatly different depending on the situation such as a movement path of the person. By generating the inter-camera information for each situation, the generation device 30 according to the second embodiment can generate inter-camera information for each situation in which the movement behavior such as a moving speed and a movement route exhibits similar tendencies. As a result, with the information processing system 10 according to the second embodiment, it is possible to generate inter-camera information accurately representing the relationship between the first camera 12-1 and the second camera 12-2. In addition, with the information processing system 10 according to the second embodiment, since the inter-camera information for each situation generated by the generation device 30 is used, the movement of a person can be analyzed with high accuracy.

### Third Embodiment

Next, the information processing system 10 according to a third embodiment will be described. Since the information processing system 10 according to the third embodiment has substantially the same constituents and functions as those of the information processing system 10 according to the first embodiment described with reference to FIGS. 1 to 4, the same reference numbers are given for substantially the same constituents, and detailed descriptions are omitted except for points of difference.

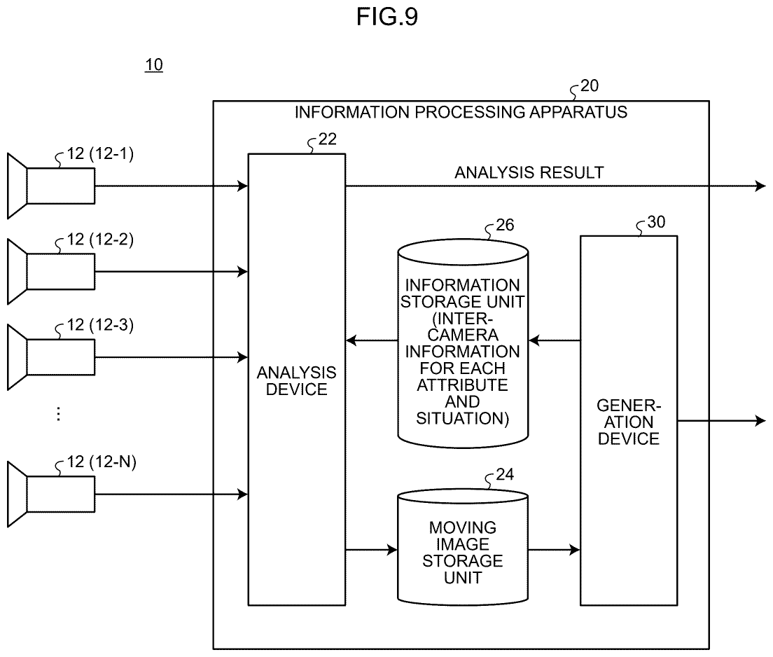

FIG. 9 is a diagram illustrating a configuration of the information processing system 10 according to the third embodiment.

The generation device 30 generates the inter-camera information for each attribute and each situation, for each set of two cameras 12 included in the plurality of cameras 12. The generation device 30 stores the generated inter-camera information for each attribute and each situation in the information storage unit 26. In addition, the generation device 30 may output the generated inter-camera information for each attribute and each situation to an external device or may display the generated inter-camera information for each attribute and each situation on a display device.

The information storage unit 26 stores the inter-camera information for each attribute and each situation, for each set of two cameras 12 included in the plurality of cameras 12.

Here, the analysis device 22 specifies the attribute of the person as the analysis target and the surrounding situation of the set of two cameras 12, and executes an analysis regarding the movement of the person as the analysis target, by using the inter-camera information of the specified attribute and situation among the pieces of inter-camera information for each attribute and each situation stored in the information storage unit 26. For example, the analysis device 22 executes the association processing by using the inter-camera information of the specified attribute and situation among the pieces of inter-camera information for each attribute and each situation corresponding to the set of the first camera 12-1 and the second camera 12-2.

Since the analysis device 22 according to the third embodiment performs association using the inter-camera information for each attribute and each situation, the association processing can be executed with high accuracy. Therefore, the analysis device 22 according to the third embodiment can accurately or more specifically execute an analysis regarding the movement of the person.

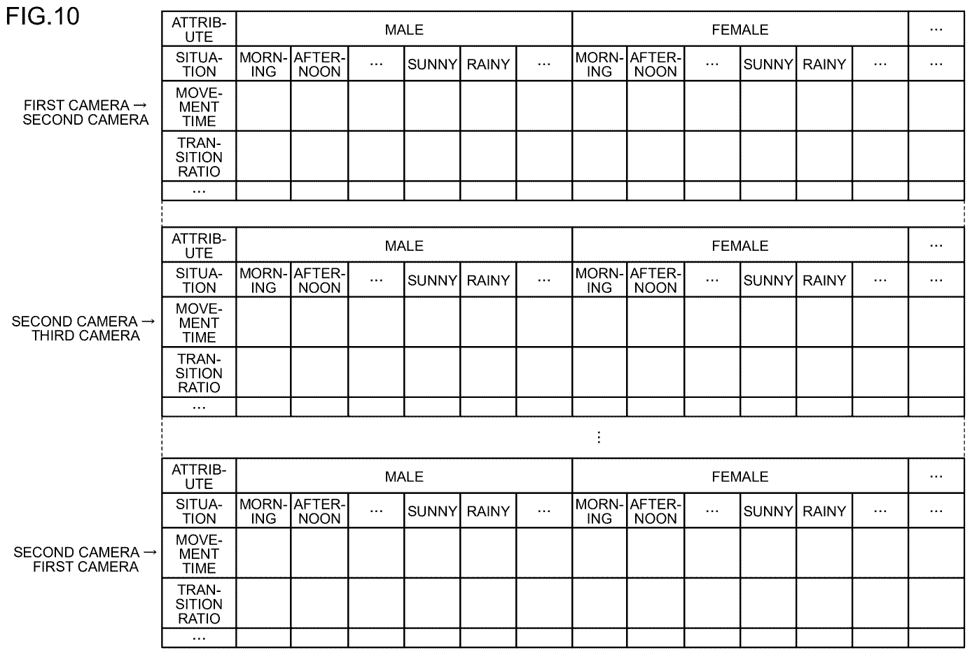

FIG. 10 is a diagram illustrating an example of the inter-camera information for each attribute and each situation according to the third embodiment.

The inter-camera information for each attribute and each situation is generated for each set of two cameras 12, which are arranged in order, included in the plurality of cameras 12. For example, the inter-camera information for each attribute and each situation includes a value of at least one item among a movement time, a transition ratio, an exit position, an entry position, an exit angle, an entry angle, an exit direction, and an entry direction.

In addition, the inter-camera information for each attribute and each situation includes a value of each item for each of the plurality of attributes and the plurality of situations. That is, the inter-camera information for each attribute and each situation includes a value of each item for each combination of at least one attribute of the plurality of attributes and at least one situation of the plurality of situations.

For example, each of the plurality of attributes represents any of gender, age group, clothing, social role, presence or absence of predetermined belongings, belongings, presence or absence of accompanying other persons, an action, posture, and facial expression. For example, each of the plurality of situations represents any of a time zone, a day, a month, a day of the week, a congestion level, weather information, presence or absence of an obstacle, an imaging direction of the first camera 12-1, and an imaging direction of the second camera 12-2.

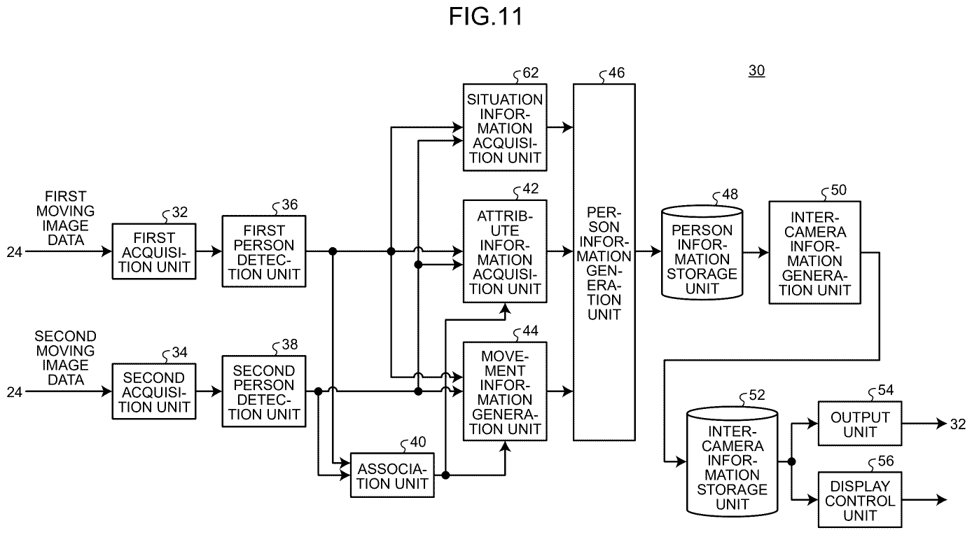

FIG. 11 is a diagram illustrating a configuration of the generation device 30 according to the third embodiment.

In a case of being compared with the generation device 30 according to the first embodiment, the generation device 30 according to the third embodiment further includes the situation information acquisition unit 62. The situation information acquisition unit 62 has a function similar to that of the second embodiment.

In the third embodiment, the person information generation unit 46 generates person information including one or more corresponding attributes, one or more corresponding situations, and movement information for the target person included in the associated first person image and second person image. In a case where there is a plurality of target persons, the person information generation unit 46 generates the person information for each of the plurality of target persons.

In addition, the person information generation unit 46 may generate, for the person included in the first person image that is not associated with any second person image, person information including one or more corresponding attributes, one or more corresponding situations, and information indicating that the person has exited the imaging range of the first camera 12-1 but has not entered the imaging range of the second camera 12-2.

In addition, the person information generation unit 46 may generate, for the person included in the second person image that is not associated with any first person image, person information including one or more corresponding attributes, one or more corresponding situations, and information indicating that the person has entered the imaging range of the second camera 12-2 without exiting the imaging range of the first camera 12-1.

The inter-camera information generation unit 50 generates the inter-camera information regarding the mobile object by statistically processing the movement information according to the attribute information and the situation information. More specifically, the inter-camera information generation unit 50 generates the inter-camera information of the set of the first camera 12-1 and the second camera 12-2 for each of the plurality of attributes and the plurality of situations on the basis of the person information of each of the plurality of persons stored in the person information storage unit 48. Then, the inter-camera information generation unit 50 stores the inter-camera information for each of the plurality of attributes and the plurality of situations in the inter-camera information storage unit 52.

In the third embodiment, the output unit 54 writes the inter-camera information for each of the plurality of attributes and the plurality of situations stored in the inter-camera information storage unit 52, as the inter-camera information for each attribute and each situation in the information storage unit 26. In the third embodiment, the display control unit 56 displays the generated inter-camera information for each of the plurality of attributes and the plurality of situations on the display device or the like in accordance with, for example, a user's operation or the like.

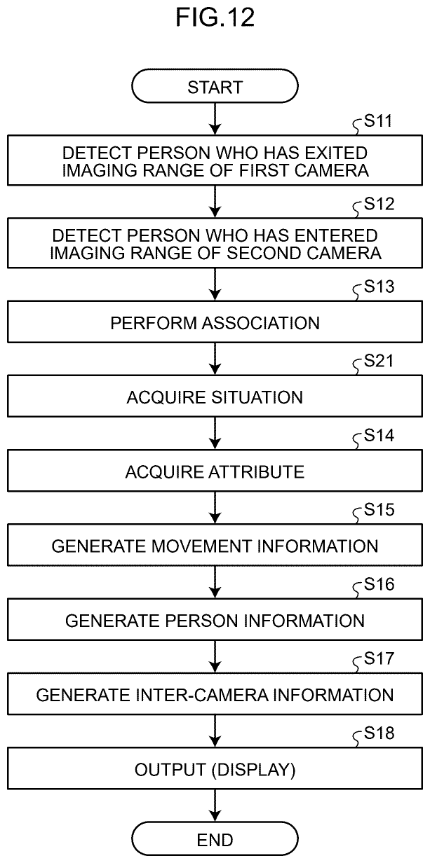

FIG. 12 is a flowchart illustrating a flow of processing of the generation device 30 according to the third embodiment. The generation device 30 according to the third embodiment executes processing in the flow illustrated in FIG. 12, for example.

In a case of being compared with the generation device 30 according to the first embodiment, the generation device 30 according to the third embodiment further executes processing of S21. Therefore, for the generation device 30 according to the third embodiment, the processing from S21 onward will be described.

The generation device 30 according to the third embodiment additionally executes the processing of S21 after executing the processing of S13.

Subsequently, in S21, the generation device 30 acquires one or more corresponding situations at the time of the movement of the target person included in the associated first person image and second person image, among the plurality of predetermined situations. In addition, the generation device 30 acquires one or more corresponding situations for the person included in the first person image that is not associated with any second person image and the person included in the second person image that is not associated with any first person image.

Subsequent to S21, in S14, the generation device 30 acquires one or more corresponding attributes representing the property or feature of the target person included in the associated first person image and second person image, among the plurality of predetermined attributes. In addition, the generation device 30 acquires one or more corresponding attributes for the person included in the first person image that is not associated with any second person image and the person included in the second person image that is not associated with any first person image.

Note that the generation device 30 may execute the processing of S21 after S14, or may execute S14 and S21 in parallel.

Subsequently, in S15, the generation device 30 generates the movement information for the target person included in the associated first person image and second person image.

Subsequently, in S16, the generation device 30 generates person information including one or more corresponding situations and movement information for the target person included in the associated first person image and second person image. In addition, for a person included in the first person image that is not associated with any second person image and a person included in the second person image that is not associated with any first person image, the generation device 30 also generates person information including one or more corresponding situations and information indicating that the person has not moved from the imaging range of the first camera 12-1 to the imaging range of the second camera 12-2.

Subsequently, in S17, the generation device 30 generates the inter-camera information of the set of the first camera 12-1 and the second camera 12-2 for each of the plurality of attributes and the plurality of situations on the basis of the person information of each of the plurality of persons.

Subsequently, in S18, the generation device 30 outputs the inter-camera information for each of the plurality of attributes and the plurality of situations, as the inter-camera information for each attribute and each situation to the information storage unit 26. In addition, the generation device 30 may display the generated inter-camera information for each of the plurality of attributes and the plurality of situations on a display device or the like.

When the processing of S18 is completed, the generation device 30 ends this flow.

As described above, the generation device 30 according to the third embodiment generates, for each attribute and each situation, inter-camera information representing the relationship between the first camera 12-1 and the second camera 12-2 in a case where the person moves from the imaging range of the first camera 12-1 to the imaging range of the second camera 12-2. As a result, with the information processing system 10 according to the third embodiment, it is possible to generate inter-camera information accurately representing the relationship between the first camera 12-1 and the second camera 12-2. In addition, with the information processing system 10 according to the third embodiment, since the inter-camera information for each attribute and each situation generated by the generation device 30 is used, the movement of a person can be analyzed with high accuracy.

### Fourth Embodiment

Next, the information processing system 10 according to a fourth embodiment will be described. Since the information processing system 10 according to the fourth embodiment has substantially the same constituents and functions as those of the information processing system 10 according to the first embodiment described with reference to FIGS. 1 to 4, the same reference numbers are given for substantially the same constituents, and detailed descriptions are omitted except for points of difference.

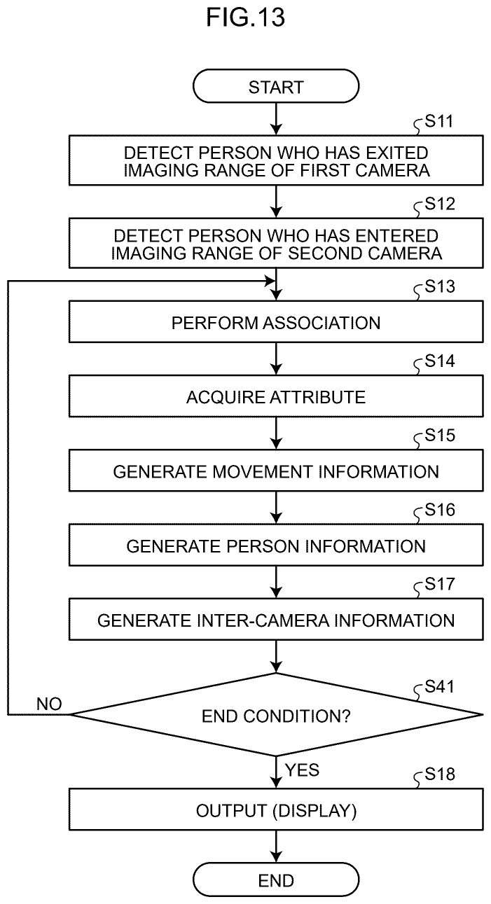

FIG. 13 is a flowchart illustrating a flow of processing of the generation device 30 according to the fourth embodiment. The generation device 30 according to the fourth embodiment executes processing in the flow illustrated in FIG. 13, for example.

The generation device 30 according to the fourth embodiment first executes the processing from S11 to S17 similarly to the generation device 30 according to the first embodiment. After S17, the generation device 30 advances the processing to S41.

In S41, the generation device 30 determines whether or not an end condition set in advance is reached. For example, in a case where the generation device 30 executes the processing of S17 a preset number of times, it is determined that the end condition is reached. Alternatively, the generation device 30 may determine that the end condition is reached in a case where a preset time has elapsed. In a case where the end condition is not reached (No in S41), the generation device 30 causes the processing to return to S13.

In the processing of S13 of the second and subsequent times, the generation device 30 re-associates each of the plurality of first person images with the second person image estimated to include the same person as the corresponding first person image among the plurality of second person images on the basis of the inter-camera information generated in the immediately preceding processing of S17. That is, in the processing of S13 of the second and subsequent times, the generation device 30 executes the association processing again using the inter-camera information generated in the immediately preceding processing of S17. As a result, in the processing of S13 of the second and subsequent times, the generation device 30 can execute the association processing with higher accuracy than the association processing in S13 of the first time.

In S14 to S16 of the second and subsequent times, the generation device 30 executes processing using the result of re-association. Then, in S17 of the second and subsequent times, the generation device 30 generates new inter-camera information, and rewrites the inter-camera information generated in the immediately preceding processing of S17.

The generation device 30 according to the fourth embodiment can improve the accuracy of the inter-camera information. Note that the generation device 30 according to the second embodiment and the generation device 30 according to the third embodiment may also execute the association processing again on the basis of the generated inter-camera information, similarly to the fourth embodiment.

### Display Example

Next, a display example of the inter-camera information by the information processing system 10 according to the first to fourth embodiments will be described.

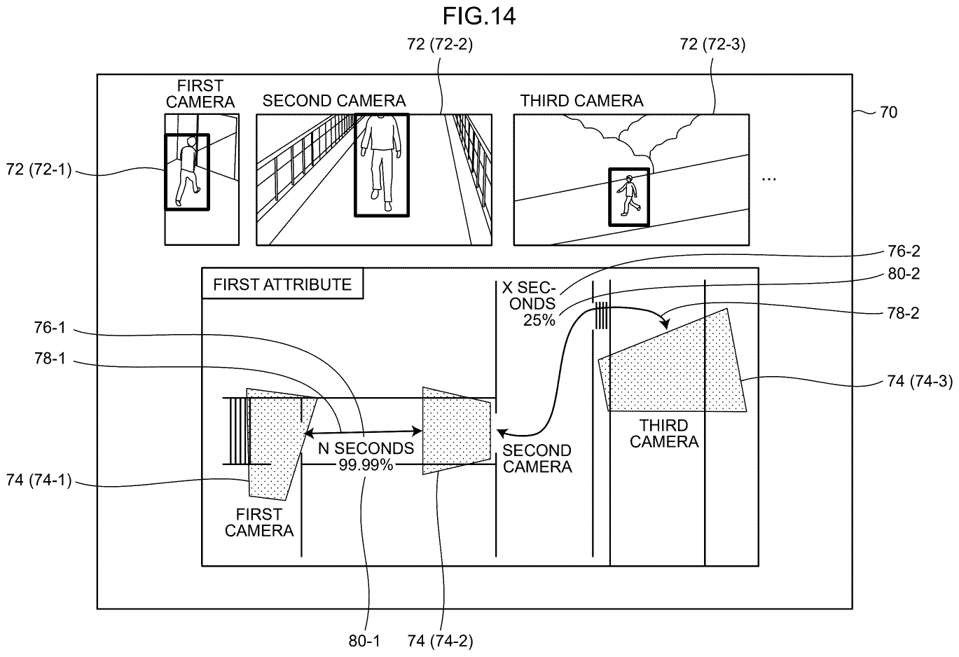

FIG. 14 is a diagram illustrating a first display image 70 by the information processing system 10 according to the first to fourth embodiments.

The information processing apparatus 20 may display the first display image 70 on the display device in a case where an analysis regarding the movement of a person, such as tracking of a specific person, is performed.

The first display image 70 includes, for each of the plurality of cameras 12, a person image 72 at a time point including a specific person in the moving image data. For example, the first display image 70 includes a first person image 72-1 captured by the first camera 12-1, a second person image 72-2 captured by the second camera 12-2, and a third person image 72-3 captured by the third camera 12-3. As a result, the user can visually check the specific person from the first display image 70.

Furthermore, the first display image 70 includes an imaging range image 74 indicating the imaging range for each of the plurality of cameras 12 on a map image including a movement path of the specific person. For example, the first display image 70 includes a first imaging range image 74-1 indicating the imaging range of the first camera 12-1, a second imaging range image 74-2 indicating the imaging range of the second camera 12-2, and a third imaging range image 74-3 indicating the imaging range of the third camera 12-3 at corresponding positions on the map image. As a result, the user can visually check the position of the specific person in in the person image 72, on the map.

Furthermore, the first display image 70 includes a value of at least one item included in the inter-camera information.

For example, the first display image 70 includes first time information 76-1 indicating the movement time included in the inter-camera information of the set of the first camera 12-1 and the second camera 12-2, in a region between the first imaging range image 74-1 and the second imaging range image 74-2. In addition, the first display image 70 includes a first arrow image 78-1 indicating the exit position, the exit angle, the entry position, and the entry angle included in the inter-camera information of the set of the first camera 12-1 and the second camera 12-2. The first arrow image 78-1 is disposed at a corresponding position and at a corresponding angle on the map image. In addition, the first display image 70 includes first ratio information 80-1 indicating the transition ratio included in the inter-camera information of the set of the first camera 12-1 and the second camera 12-2, in a region between the first imaging range image 74-1 and the second imaging range image 74-2.

In addition, the first display image 70 includes second time information 76-2 indicating the movement time included in the inter-camera information of the set of the second camera 12-2 and the third camera 12-3, in a region between the second imaging range image 74-2 and the third imaging range image 74-3. In addition, the first display image 70 includes a second arrow image 78-2 indicating the exit position, the exit angle, the entry position, and the entry angle included in the inter-camera information of the set of the second camera 12-2 and the third camera 12-3. The second arrow image 78-2 is disposed at a corresponding position and at a corresponding angle on the map image. In addition, the first display image 70 includes second ratio information 80-2 indicating the transition ratio included in the inter-camera information of the set of the second camera 12-2 and the third camera 12-3, in a region between the second imaging range image 74-2 and the third imaging range image 74-3.

By displaying such a first display image 70, the information processing apparatus 20 can cause the user to recognize the movement of the specific person included in the person image 72 while visually checking the inter-camera information, for example.

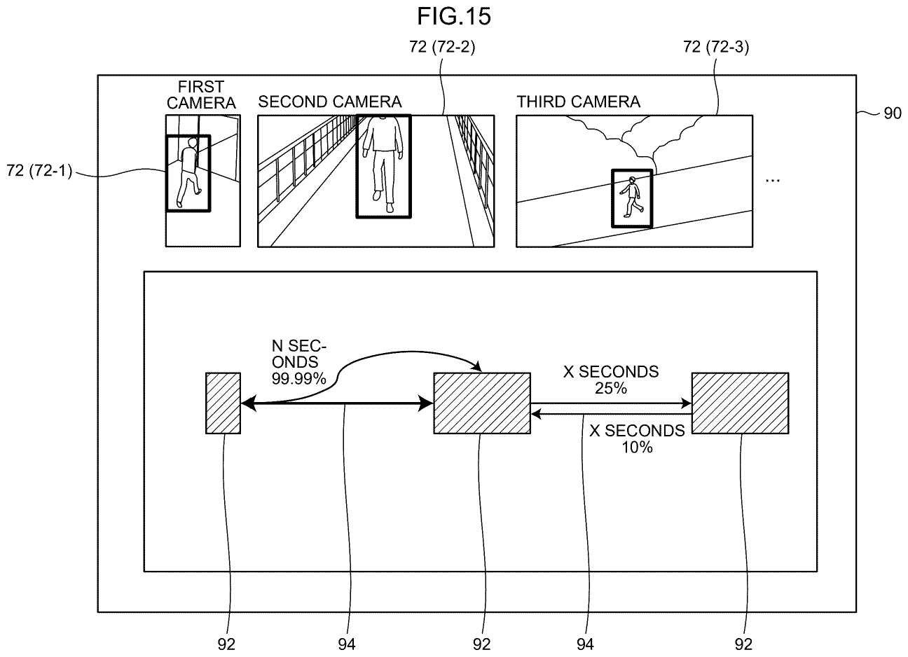

FIG. 15 is a diagram illustrating a second display image 90 by the information processing system 10 according to the first to fourth embodiments.

The information processing apparatus 20 may display the second display image 90 on the display device in a case where an analysis regarding the movement of a person, such as tracking of a specific person, is performed.

Similarly to the first display image 70 illustrated in FIG. 14, the second display image 90 includes, for each of the plurality of cameras 12, the person image 72 at a time point including a specific person in the moving image data. As a result, the user can visually check the specific person from the second display image 90.

The second display image 90 includes an image representing a directed graph in which each of the plurality of cameras 12 is represented as a node 92 and a connection relationship of a set of two cameras 12 represented by the inter-camera information is represented as an edge 94. In this case, the size or shape of the node 92 may be changed, for example, according to the size or shape of the imaging range of the corresponding camera 12.

In addition, the edge 94 may include a value of a predetermined item included in the corresponding inter-camera information, as an edge weight. In addition, the thickness, color, and line type of the edge 94 may be changed for each attribute or situation. The line type is a solid line, a broken line, a double line, or the like. In addition, the edge 94 may additionally include text information representing the attribute or situation in association with the edge weight.

By displaying such a second display image 90, the information processing apparatus 20 can cause the user to recognize the movement of the specific person included in the person image 72 while visually checking the inter-camera information for each attribute or each situation, for example.

### Hardware Configuration and the Like of Information Processing Apparatus 20

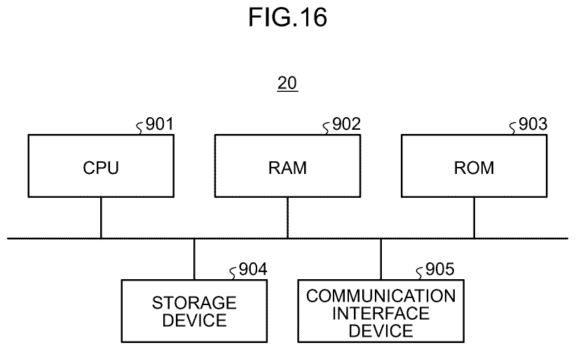

FIG. 16 is a diagram illustrating an example of a hardware configuration of the information processing apparatus 20. The information processing apparatus 20 is realized by a computer having a hardware configuration as illustrated in FIG. 16, for example. The information processing apparatus 20 includes a central processing unit (CPU) 901, a random access memory (RAM) 902, a read only memory (ROM) 903, a storage device 904, and a communication interface device 905. These units are connected by a bus.

The CPU 901 is one or more processors that execute arithmetic processing, control processing, and the like according to a program. The CPU 901 executes various kinds of processing by using a predetermined area of the RAM 902 as a work area, in cooperation with the programs stored in the ROM 903, the storage device 904, and the like.

The RAM 902 is a memory such as a synchronous dynamic random access memory (SDRAM). The RAM 902 functions as a work area of the CPU 901. The ROM 903 is a memory that stores programs and various kinds of information in a non-rewritable manner.

The storage device 904 is a device that writes and reads data in and from a semiconductor storage medium such as a flash memory, a magnetically or optically recordable storage medium, or the like. The storage device 904 writes and reads data to and from the storage medium under the control of the CPU 901. The communication interface device 905 communicates with an external device via a network under the control of the CPU 901.

The program executed by the computer causes the computer to function as the information processing apparatus 20. This program is developed and executed on the RAM 902 by the CPU 901 (processor).

In addition, the program executed by the computer is provided by being recorded in a computer-readable recording medium such as a CD-ROM, a flexible disk, a CD-R, or a digital versatile disk (DVD) as a file in a format that can be installed or executed in the computer.

In addition, the program may be provided by being stored in a computer connected to a network such as the Internet and downloaded via the network. In addition, the program may be provided or distributed via a network such as the Internet. In addition, the program executed by the information processing apparatus 20 may be provided by being incorporated in the ROM 903 or the like in advance.

The program for causing the computer to function as the information processing apparatus 20 includes, for example, a first acquisition module, a second acquisition module, a first person detection module, a second person detection module, an association module, an attribute information acquisition module, a movement information generation module, a person information generation module, an association information generation module, an output module, and a display control module. The computer program product may further include a situation information acquisition module. This program is executed by the CPU 901 to load each module into the RAM 902, and causes the CPU 901 to function as the first acquisition unit 32, the second acquisition unit 34, the first person detection unit 36, the second person detection unit 38, the association unit 40, the attribute information acquisition unit 42, the movement information generation unit 44, the person information generation unit 46, the inter-camera information generation unit 50, the output unit 54, and the display control unit 56. This program may further function as the situation information acquisition unit 62. In a case where the CPU 901 is a plurality of processors, the functions of these units may be distributed among the processors. Note that some or all of these configurations may be configured by hardware. In addition, this program causes the RAM 902 and the storage device 904 to function as the person information storage unit 48 and the inter-camera information storage unit 52.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to perform information processing on images captured by a plurality of cameras, the information processing apparatus comprising:
one or more hardware processors configured to function as:
an association unit that associates, in a case where a mobile object detected from a first image captured by a first camera and a mobile object detected from a second image captured by a second camera are estimated to be the same, the mobile object detected from the first image with the mobile object detected from the second image;
an attribute information acquisition unit that acquires attribute information regarding a property or feature of the mobile object from an image;
a movement information generation unit that generates movement information regarding movement of the associated mobile object from an imaging range of the first camera related to the first image to an imaging range of the second camera related to the second image; and
an inter-camera information generation unit that generates inter-camera information regarding the mobile object by statistically processing the movement information according to the attribute information.

2. The information processing apparatus according to claim 1, wherein
the inter-camera information and the movement information include a value representing at least one of a movement time, an exit position, an entry position, an exit angle, an entry angle, an exit direction, and an entry direction,
the movement time represents a time until the mobile object enters the imaging range of the second camera after exiting the imaging range of the first camera,
the exit position represents a position where the mobile object, which exits the imaging range of the first camera and enters the imaging range of the second camera, exits the imaging range of the first camera,
the entry position represents a position where the mobile object, which exits the imaging range of the first camera and enters the imaging range of the second camera, enters the imaging range of the second camera,
the exit angle represents an angle or orientation of the mobile object, which exits the imaging range of the first camera and enters the imaging range of the second camera, with respect to the first camera at a time point when the mobile object exits the imaging range of the first camera,
the entry angle represents an angle or orientation of the mobile object, which exits the imaging range of the first camera and enters the imaging range of the second camera, with respect to the second camera at a time point when the mobile object enters the imaging range of the second camera,
the exit direction represents a movement direction of the mobile object, which exits the imaging range of the first camera and enters the imaging range of the second camera, at a time point when the mobile object exits the imaging range of the first camera, and
the entry direction represents a movement direction of the mobile object, which exits the imaging range of the first camera and enters the imaging range of the second camera, at a time point when the mobile object enters the imaging range of the second camera.

3. The information processing apparatus according to claim 2, wherein
the inter-camera information generation unit performs statistical calculation on the movement information of each of a plurality of mobile objects, for each of a plurality of pieces of attribute information, and generates the inter-camera information of each of the plurality of pieces of attribute information.

4. The information processing apparatus according to claim 3, wherein
the inter-camera information generation unit includes an average value, a median, a standard deviation, or a quartile deviation of values included in the movement information of each of the plurality of mobile objects for each of the plurality of pieces of attribute information, in the inter-camera information for each of the plurality of pieces of attribute information.

5. The information processing apparatus according to claim 1, wherein
the inter-camera information includes a transition ratio, and
the transition ratio represents a ratio of a number of mobile objects that have entered the imaging range of the second camera from the imaging range of the first camera with respect to a number of mobile objects that have exited the imaging range of the first camera.

6. The information processing apparatus according to claim 1, wherein
the inter-camera information includes a transition ratio, and
the transition ratio represents a ratio of a number of mobile objects that have entered the imaging range of the second camera from the imaging range of the first camera with respect to the number of mobile objects that have entered the imaging range of the second camera.

7. The information processing apparatus according to claim 1, wherein
the mobile object is a person, and
the attribute information represents any of gender, age group, clothing, social role, presence or absence of predetermined belongings, belongings, presence or absence of accompanying other mobile objects, an action, posture, and facial expression.

8. The information processing apparatus according to claim 1, wherein
after the inter-camera information is generated,
the association unit re-associates the mobile object detected from the first image with the mobile object detected from the second image on a basis of the generated inter-camera information,
the attribute information acquisition unit re-acquires the attribute information regarding the re-associated mobile object,
the movement information generation unit re-generates the movement information regarding the re-associated mobile object, and
the inter-camera information generation unit re-generates the inter-camera information regarding the re-associated mobile object by statistically processing the re-generated movement information according to the re-generated attribute information.

9. The information processing apparatus according to claim 1, wherein
the one or more hardware processors are configured to further function as:
a display control unit that displays the inter-camera information on a display device.

10. An information processing apparatus configured to perform information processing on images captured by a plurality of cameras, the information processing apparatus comprising:
an association unit that associates, in a case where a mobile object detected from a first image captured by a first camera and a mobile object detected from a second image captured by a second camera are estimated to be the same, the mobile object detected from the first image with the mobile object detected from the second image;
a situation information acquisition unit that acquires situation information representing a surrounding situation of the associated mobile object;
a movement information generation unit that generates movement information regarding movement of the associated mobile object from an imaging range of the first camera related to the first image to an imaging range of the second camera related to the second image; and
an inter-camera information generation unit that generates inter-camera information regarding the mobile object by statistically processing the movement information according to the situation information.

11. The information processing apparatus according to claim 10, wherein
the situation information represents any of a time zone, a day and month, a day of a week, a congestion level, weather information, presence or absence of an obstacle, an imaging direction of the first camera, and an imaging direction of the second camera.

12. The information processing apparatus according to claim 10, wherein
the one or more hardware processors are configured to further function as:
an attribute information acquisition unit that acquires attribute information regarding a property or feature of the mobile object from an image, wherein
the inter-camera information generation unit generates the inter-camera information on a basis of the attribute information, the situation information, and the movement information.

13. An information processing system comprising:
a plurality of cameras;
an analysis device that performs an analysis regarding movement of a mobile object on a basis of moving image data captured by each of the plurality of cameras; and
the information processing apparatus according to claim 1, wherein
the information processing apparatus generates the inter-camera information by setting any one of the plurality of cameras as the first camera and any one of the plurality of cameras, which is different from the first camera, as the second camera, and
the analysis device performs an analysis of the mobile object that moves from the imaging range of the first camera to the imaging range of the second camera by using the inter-camera information.

14. An information processing method implemented by a computer of an information processing apparatus configured to perform information processing on images captured by a plurality of cameras, the information processing method comprising:
associating, in a case where a mobile object detected from a first image captured by a first camera and a mobile object detected from a second image captured by a second camera are estimated to be the same, the mobile object detected from the first image with the mobile object detected from the second image;
acquiring attribute information regarding a property or feature of the mobile object from an image;
generating movement information regarding movement of the associated mobile object from an imaging range of the first camera related to the first image to an imaging range of the second camera related to the second image; and
generating inter-camera information regarding the mobile object by statistically processing the movement information according to the attribute information.

15. An information processing method implemented by a computer of an information processing apparatus configured to perform information processing on images captured by a plurality of cameras, the information processing method comprising:
associating in a case where a mobile object detected from a first image captured by a first camera and a mobile object detected from a second image captured by a second camera are estimated to be the same, the mobile object detected from the first image with the mobile object detected from the second image;
acquiring situation information representing a surrounding situation of the associated mobile object;
generating movement information regarding movement of the associated mobile object from an imaging range of the first camera related to the first image to an imaging range of the second camera related to the second image; and
generating inter-camera information regarding the mobile object by statistically processing the movement information according to the situation information.

16. A computer program product having a non-transitory computer readable medium including programmed instructions stored thereon, wherein the instructions, when executed by a computer, cause the computer to function as:
an association unit that associates, in a case where a mobile object detected from a first image captured by a first camera and a mobile object detected from a second image captured by a second camera are estimated to be the same, the mobile object detected from the first image with the mobile object detected from the second image;
an attribute information acquisition unit that acquires attribute information regarding a property or feature of the mobile object from an image;
a movement information generation unit that generates movement information regarding movement of the associated mobile object from an imaging range of the first camera related to the first image to an imaging range of the second camera related to the second image; and
an inter-camera information generation unit that generates inter-camera information regarding the mobile object by statistically processing the movement information according to the attribute information.

17. A computer program product having a non-transitory computer readable medium including programmed instructions stored thereon, wherein the instructions, when executed by a computer, cause the computer to function as:
an association unit that associates, in a case where a mobile object detected from a first image captured by a first camera and a mobile object detected from a second image captured by a second camera are estimated to be the same, the mobile object detected from the first image with the mobile object detected from the second image;
a situation information acquisition unit that acquires situation information representing a surrounding situation of the associated mobile object;
a movement information generation unit that generates movement information regarding movement of the associated mobile object from an imaging range of the first camera related to the first image to an imaging range of the second camera related to the second image; and
an inter-camera information generation unit that generates inter-camera information regarding the mobile object by statistically processing the movement information according to the situation information.
